(19) United States
(12) Patent Application Publication
(10) Pub. No.: US 2025/0335102 A1
(43) Pub. Date: Oct. 30, 2025

(54) SYSTEMS AND METHODS FOR MAXIMIZING ENDURANCE AND PERFORMANCE OF SOLID STATE DRIVES BY TRAINING WITH DEVICE-LEVEL TELEMETRY

(71) Applicant: Dell Products L.P., Round Rock, TX (US)

(72) Inventors: Kurt W. DORSEY, New Braunfels, TX (US); Colm MURPHY, Cork (IE); James A.B. GRAHAM, Austin, TX (US)

(73) Assignee: Dell Products L.P., Round Rock, TX (US)

(21) Appl. No.: 18/646,109

(22) Filed: Apr. 25, 2024

(51) Int. Cl. G06F 3/06; G06F 11/34

(52) U.S. Cl. CPC G06F 3/0616; G06F 3/0631; G06F 3/0679; G06F 11/3433

(57) ABSTRACT

An information handling system may include a processor, a storage unit communicatively coupled to the processor, and logic configured to, after namespaces are provisioned on the storage unit and before overprovisioning has been allocated to the namespaces: cause a processing workload to be executed that performs write operations to and read operations from the storage unit, collect telemetry information regarding write operations and read operations for each of the namespaces, and based on the telemetry information, allocate respective overprovisioning to each of the namespaces.

### TECHNICAL FIELD

The present disclosure relates in general to information handling systems, and more particularly to systems and methods for maximizing endurance and performance of solid state drives in an information handling system by training the solid state drives with device-level telemetry data.

### BACKGROUND

As the value and use of information continues to increase, individuals and businesses seek additional ways to process and store information. One option available to users An information handling is information handling systems. system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

According to the Non-Volatile Memory Express (NVMe) 2.0 protocol, solid state drives may have multiple endurance ratings, including a user ability to establish multiple endurance groups within a solid state drive with a respective overprovisioning in each endurance group. In accordance with the protocol, such setting of multiple endurance groups with overprovisioning is performed once at creation of a namespace and once the device is “created,” such overprovisioning cannot be changed without reprovisioning the solid state drive, which requires loss of stored data.

Each user and each environment using solid state drives may have their own unique workload and these workloads may vary from being very read intensive (e.g., 90% read/10% write), to mixed use (e.g., 70% read/30% write) or write intensive (e.g., 30% or more writes). If a user creates a read-intensive endurance group yet the actual workload is write-intensive, then the solid state drive may not survive the warrantied period and the performance for the drive may be lower than anticipated. On the other hand, if a user creates a write-intensive endurance group yet the actual workload is read-intensive, then the drive may include more overprovisioning than needed, and will thus have lesser storage capacity than if it were properly provisioned as a read-intensive drive.

### SUMMARY

In accordance with the teachings of the present disclosure, the disadvantages and problems associated with existing approaches to maximizing endurance and performance of a solid state drive may be reduced or eliminated.

In accordance with embodiments of the present disclosure, an information handling system may include a processor, a storage unit communicatively coupled to the processor, and logic configured to, after namespaces are provisioned on the storage unit and before overprovisioning has been allocated to the namespaces: cause a processing workload to be executed that performs write operations to and read operations from the storage unit, collect telemetry information regarding write operations and read operations for each of the namespaces, and based on the telemetry information, allocate respective overprovisioning to each of the namespaces.

In accordance with these and other embodiments of the present disclosure, a method may include, after namespaces are provisioned on a storage unit of an information handling system and before overprovisioning has been allocated to the namespaces, causing a processing workload to be executed that performs write operations to and read operations from the storage unit, collecting telemetry information regarding write operations and read operations for each of the namespaces, and based on the telemetry information, allocating respective overprovisioning to each of the namespaces.

In accordance with these and other embodiments of the present disclosure, an article of manufacture may include a non-transitory computer readable medium and computer-executable instructions carried on the computer readable medium, the instructions readable by a processor, the instructions, when read and executed, for causing the processor to, after namespaces are provisioned on a storage unit of an information handling system and before overprovisioning has been allocated to the namespaces: cause a processing workload to be executed that performs write operations to and read operations from the storage unit, collect telemetry information regarding write operations and read operations for each of the namespaces, and based on the telemetry information, allocate respective overprovisioning to each of the namespaces.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of a storage unit, in accordance with embodiments of the present disclosure;

FIG. 3 illustrates a flow chart of an example method maximizing endurance and performance of a solid state drive by training the solid state drive with device-level telemetry data, in accordance with embodiments of the present disclosure; and

FIG. 4 illustrates another block diagram of a storage unit, in accordance with embodiments of the present disclosure.

### DETAILED DESCRIPTION

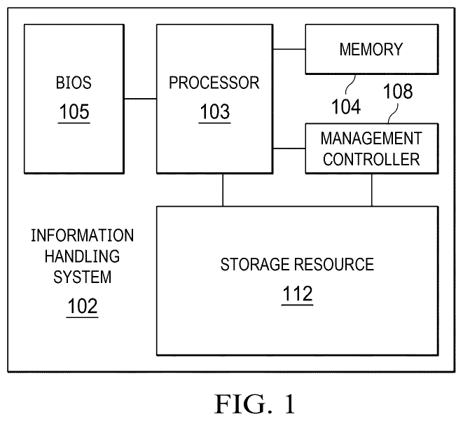

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input and output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, buses, memories, input-output devices and/or interfaces, storage resources, network interfaces, motherboards, electro-mechanical devices (e.g., fans), displays, and power supplies.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (“RAM”), read-only memory (“ROM”), electrically erasable programmable read-only memory (“EEPROM”), and/or flash memory; as well as communications media such as wires, optical fibers, microwaves, radio waves, and other electromagnetic and/or optical carriers; and/or any combination of the foregoing.

Information handling systems often use an array of physical storage resources (e.g., disk drives), such as a Redundant Array of Independent Disks (“RAID”), for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.” Implementations of physical storage resource arrays can range from a few physical storage resources disposed in a chassis, to hundreds of physical storage resources disposed in one or more separate storage enclosures.

FIG. 1 illustrates a block diagram of an example information handling system 102, in accordance with embodiments of the present disclosure. In some embodiments, information handling system 102 may comprise a server. In these and other embodiments, information handling system 102 may comprise a personal computer. In other embodiments, information handling system 102 may be a portable computing device (e.g., a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, a management controller 108 communicatively coupled to processor 103, and a storage resource 112 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 105, storage resources 112, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., memory 104) may be executed by processor 103 and given control of information handling system 102.

Management controller 108 may be configured to provide management facilities for management of information handling system 102. Such management may be made by management controller 108 even if information handling system 102 is powered off or powered to a standby state. Management controller 108 may include any suitable components for carrying out its functionality, including without limitation a processor, memory, and a network interface separate from and physically isolated from an in-band network interface of information handling system 102. In certain embodiments, management controller 108 may include or may be an integral part of a baseboard management controller (BMC), a remote access controller (e.g., a Dell Remote Access Controller or Integrated Dell Remote Access Controller), or an enclosure controller. In other embodiments, management controller 108 may include or may be an integral part of a chassis management controller (CMC).

Storage resource 112 may be disposed in one or more storage enclosures configured to hold and power storage resource 112. Storage resource 112 may include hard disk drives, magnetic tape libraries, optical disk drives, magneto-optical disk drives, compact disk drives, compact disk arrays, disk array controllers, Non-Volatile Memory Express (NMVe) storage resources, and/or any other system, apparatus or device operable to store media. In particular embodiments, storage resource 112 may include a solid state drive.

In addition to processor 103, memory 104, BIOS 105, management controller 108, and storage resource 112, information handling system 102 may include one or more other information handling resources.

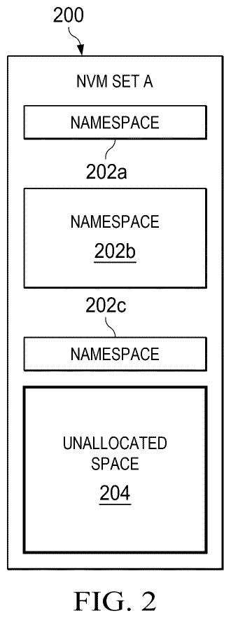

FIG. 2 illustrates a block diagram of a storage unit 200, in accordance with embodiments of the present disclosure. In some embodiments, storage unit 200 may be a physical storage resource, such as storage resource 112 depicted in FIG. 1, for example. In other embodiments, storage unit 200 may be a virtual storage resource, for example an NVMe set for which multiple virtual storage resources may be provisioned within a single physical storage resource or across multiple storage resources. As shown in FIG. 2, storage unit 200 may be divided into usable space comprising one or more namespaces 202 (e.g., namespaces 202a, 202b, 202c) and unallocated space 204.

Each namespace 202 may comprise a partition/volume upon which data may be stored.

Unallocated space 204 may comprise physical storage space allocated within storage unit 200 to act as overprovisioning, or in other words a swap space for write and erase operations in order to maximize the speed of writes as well as being used as spare blocks for storage as the lifetime of the drive comprising storage unit 200 ages. The more overprovisioning a drive has allocated, the more endurance the drive may have which may also maximize write performance.

In operation, as described in greater detail below, management controller 108, and/or another component of information handling system 102, may at the time of provisioning a storage unit 200, collect telemetry information associated with storage unit 200 during execution of a sample processing workload that utilizes storage unit 200, and overprovision individual namespaces 202 based on such collected telemetry information. For example, the telemetry information may include total bytes read from and written to each namespace 202 during execution of the processing workload, and overprovisioning of individual namespaces 202 may be based on drive utilization, total bytes written, and a ratio between total bytes written and total bytes read during execution of the processing workload.

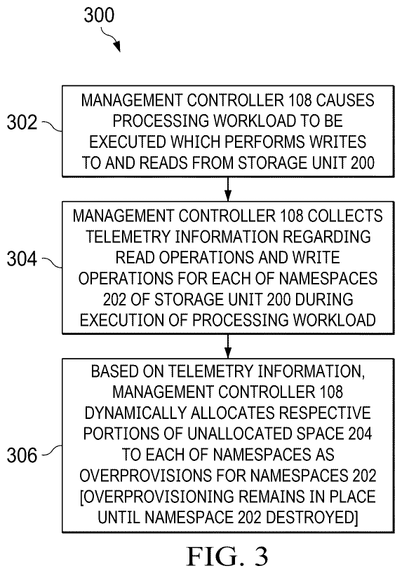

FIG. 3 illustrates a flow chart of an example method 300 for maximizing endurance and performance of a solid state drive (e.g., storage resource 112, storage unit 200) by training the solid state drive with device-level telemetry data, in accordance with embodiments of the present disclosure. According to certain embodiments, method 300 may begin at step 302. As noted above, teachings of the present disclosure may be implemented in a variety of configurations of information handling system 102 as shown in FIG. 1. As such, the preferred initialization point for method 300 and the order of the steps comprising method 300 may depend on the implementation chosen.

At step 302, after namespaces 202 are provisioned on storage unit 200, but prior to allocation of unallocated space 204 as overprovisioning to namespaces 202, management controller 108 may cause a processing workload to be executed which performs writes to and reads from storage unit 200. Such processing workload may be an actual workload executed by information handling system 102 comprising storage unit 200 or a sample workload representative of an actual workload.

At step 304, management controller 108 may collect telemetry information regarding read operations and write operations for each of namespaces 202 of storage unit 200 during execution of the processing workload. In some embodiments, management controller 108 may collect such telemetry information by monitoring input/output operations to/from storage unit 200. In other embodiments, such telemetry information may be collected by another component of information handling system 102 (e.g., by storage unit 200 or storage resource 112 itself) and retrieved by management controller 108. Telemetry information may include any suitable information, including without limitation total bytes read from and written to each namespace 202 during execution of the processing workload, and overprovisioning of individual namespaces 202 may be based on drive utilization, total bytes written, and a ratio between total bytes written to and total bytes read from each namespace during execution of the processing workload.

At step 306, management controller 108 may, based on the telemetry information, dynamically allocate respective portions of unallocated space 204 to each of namespaces 202 as overprovisioning for namespaces 202. For example, such allocations may be based on one or more of namespace size, drive utilization, total bytes written, and a ratio between total bytes written and total bytes read during execution of the processing workload. For example, a namespace 202 experiencing higher levels of drive utilization, total bytes written, and/or ratio between total bytes written and total bytes read may have a greater amount (e.g., as a percentage of the size of such namespace 202) of unallocated space 204 allocated as overprovisioning to such namespace 202 as compared to another namespace 202 of storage unit 200 having lower levels of drive utilization, total bytes written, and/or ratio between total bytes written and total bytes read. Once such dynamic allocation of overprovisioning has occurred for a namespace 202, such overprovisioning may not be deallocated until such namespace 202 has been destroyed.

Although FIG. 3 discloses a particular number of steps to be taken with respect to method 300, it may be executed with greater or lesser steps than those depicted in FIG. 3. In addition, although FIG. 3 discloses a certain order of steps to be taken with respect to method 300, the steps comprising method 300 may be completed in any suitable order.

Method 300 may be implemented using information handling system 102, components thereof, or any other suitable system operable to implement method 300. In certain embodiments, method 300 may be implemented partially or fully in software and/or firmware embodied in computer-readable media.

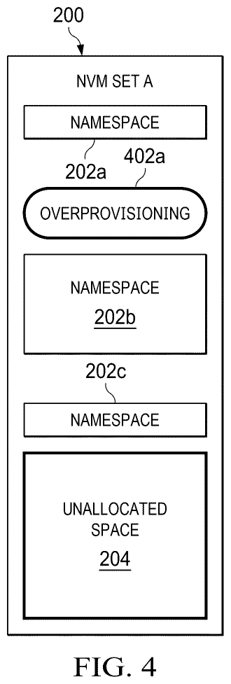

FIG. 4 illustrates another block diagram of storage unit 200, in accordance with embodiments of the present disclosure. In particular, FIG. 4 illustrates storage unit 200 after a portion of unallocated space 204 shown in FIG. 2 has been allocated as overprovisioning 402a of namespace 202a in accordance with method 300. The balance of unallocated space 204 shown in FIG. 4 may be similarly allocated to namespaces 202b and 202c, in accordance with method 300.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

1. An information handling system comprising:
a processor;
a storage unit communicatively coupled to the processor; and
logic configured to, after namespaces are provisioned on the storage unit and before overprovisioning has been allocated to the namespaces:
cause a processing workload to be executed that performs write operations to and read operations from the storage unit;
collect telemetry information regarding write operations and read operations for each of the namespaces; and
based on the telemetry information, allocate respective overprovisioning to each of the namespaces.

2. The information handling system of claim 1, wherein the storage unit comprises a solid state drive.

3. The information handling system of claim 1, wherein the storage unit comprises an endurance group provisioned on a solid state drive.

4. The information handling system of claim 1, wherein the telemetry information comprises a number of total bytes read from and a number of total bytes written to each namespace during execution of the processing workload.

5. The information handling system of claim 1, wherein the logic may further be configured to overprovision the namespaces based on one or more of drive utilization, total bytes written, and a ratio between total bytes written to and total bytes read from each namespace during execution of the processing workload.

6. The information handling system of claim 5, wherein the logic may further be configured to overprovision the namespaces based on sizes of the namespaces.

7. The information handling system of claim 1, wherein the logic comprises a management controller of the information handling system.

8. A method comprising, after namespaces are provisioned on a storage unit of an information handling system and before overprovisioning has been allocated to the namespaces:
causing a processing workload to be executed that performs write operations to and read operations from the storage unit;
collecting telemetry information regarding write operations and read operations for each of the namespaces; and
based on the telemetry information, allocating respective overprovisioning to each of the namespaces.

9. The method of claim 8, wherein the storage unit comprises a solid state drive.

10. The method of claim 8, wherein the storage unit comprises an endurance group provisioned on a solid state drive.

11. The method of claim 8, wherein the telemetry information comprises a number of total bytes read from and a number of total bytes written to each namespace during execution of the processing workload.

12. The method of claim 8, further comprising overprovisioning the namespaces based on one or more of drive utilization, total bytes written, and a ratio between total bytes written to and total bytes read from each namespace during execution of the processing workload.

13. The method of claim 12, further comprising overprovisioning the namespaces based on sizes of the namespaces.

14. An article of manufacture comprising:
a non-transitory computer readable medium; and
computer-executable instructions carried on the computer readable medium, the instructions readable by a processor, the instructions, when read and executed, for causing the processor to, after namespaces are provisioned on a storage unit of an information handling system and before overprovisioning has been allocated to the namespaces:
cause a processing workload to be executed that performs write operations to and read operations from the storage unit;
collect telemetry information regarding write operations and read operations for each of the namespaces; and
based on the telemetry information, allocate respective overprovisioning to each of the namespaces.

15. The article of claim 14, wherein the storage unit comprises a solid state drive.

16. The article of claim 14, wherein the storage unit comprises an endurance group provisioned on a solid state drive.

17. The article of claim 14, wherein the telemetry information comprises a number of total bytes read from and a number of total bytes written to each namespace during execution of the processing workload.

18. The article of claim 14, further comprising overprovisioning the namespaces based on one or more of drive utilization, total bytes written, and a ratio between total bytes written to and total bytes read from each namespace during execution of the processing workload.

19. The article of claim 18, wherein further comprising overprovisioning the namespaces based on sizes of the namespaces.
